(19) United States
(12) Patent Application Publication
(10) Pub. No.: US 2015/0186927 A1
(43) Pub. Date: Jul. 2, 2015

(54) MARKETING PORTFOLIO OPTIMIZATION

(71) Applicants: Anto Chittilappilly, Waltham, MA (US); Payman Sadegh, Alpharetta, GA (US); Rakesh Pillai, Kerala (IN); Madan Bharadwaj, Billerica, MA (US)

(72) Inventors: Anto Chittilappilly, Waltham, MA (US); Payman Sadegh, Alpharetta, GA (US); Rakesh Pillai, Kerala (IN); Madan Bharadwaj, Billerica, MA (US)

(21) Appl. No.: 14/145,521

(22) Filed: Dec. 31, 2013

(51) Int. Cl. G06Q 30/02

(52) U.S. Cl. CPC G06Q 30/0244

(57) ABSTRACT

A method, system, and computer program product for computer-aided management of marketing and advertising campaigns. Operations commence upon displaying a maximum efficiency response curve of a media portfolio, where the maximum efficiency response curve comprises a range of response values resulting from a given set of media portfolio input characteristics. A maximum efficiency ROI curve of the media portfolio is displayed, where the maximum efficiency ROI curve comprises a range of ROI values resulting from the set of media portfolio input characteristics. A user provides a prospective quantitative change to alter the media portfolio input characteristics in the media portfolio. The output response of the media portfolio to the prospective change is modeled, and suggested media plan reallocation values are displayed. An ROI value resulting from the prospective set of media portfolio input characteristics is displayed in juxtaposition to the maximum efficiency ROI curve.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

The disclosure relates to the field of computer-aided management of marketing and advertising campaigns and more particularly to techniques for forecasting and displaying results of resource allocations in marketing campaigns.

### BACKGROUND

A modern marketing and advertising campaign involves many channels (e.g., TV, radio, newspaper, web, etc.) and each channel is selected by a marketing manager to achieve a particular objective (e.g., brand recognition, lead generation, etc.). Spending or other activity in one channel (e.g., placement of TV spots, placement of radio spots, etc.) can be increased to create an increased marketplace response. In some cases, spending in one channel can produce responses in other channels. A marketing manager might include many such channels in a media portfolio, and might apportion a media spend budget across the channels in a media portfolio. In some cases additional stimulus via a particular channel might reach a “saturation point” and might not produce any additional desired effects (e.g., sending out more direct mail circulars may not produce any further responses). The effects of increasing (or decreasing) spend in one channel may impact other channels, and the impacted channels may impact other channels, and so on.

Especially in the face of such complexity, a marketing manager would want to know how to efficiently apportion their budgets across the channels in their marketing portfolio. Legacy approaches fail to sufficiently aid the marketing manager to find efficient spending mixes. Further, a marketing manager may not have complete flexibility of apportioning media spend in a fully optimized manner. For example, a marketing manager may be contractually bound to spend a certain amount within a certain time period. Legacy approaches fail to aid the marketing manager in evaluating variations from an optimal mix, even though is it common that a marketing manager is subject to constraints such as the aforementioned contractual obligations.

Still more, a marketing manager would need to quickly evaluate many variations in spending. Unfortunately recalculation of mixes of portfolio spending using legacy techniques are deficient in at least that legacy techniques are too slow and that legacy models are overly simplified models.

Techniques to interactively display marketing campaign predictions (e.g., revenue changes, changes in the number of inquiries, etc.) resulting from a particular mix of spending in a media portfolio are needed. Furthermore, techniques for displaying predictions resulting from a particular reallocation of spending in a media portfolio are needed.

None of the aforementioned legacy approaches provide the capabilities of the herein disclosed techniques for forecasting and displaying results of resource allocations in a marketing campaign. Therefore, there is a need for improvements.

### SUMMARY

The present disclosure provides an improved method, system, and computer program product suited to address the aforementioned issues with legacy approaches. More specifically, the present disclosure provides a detailed description of techniques used in methods, systems, and computer program products for forecasting and displaying the results of media portfolio input characteristics such as resource allocations in a marketing campaign.

Exemplary embodiments commence upon displaying (e.g., to a user) a maximum efficiency response curve of a media portfolio, where the maximum efficiency response curve comprises a range of response values resulting from a set of media portfolio input characteristics. Then, on the same screen, a maximum efficiency ROI curve of the media portfolio is displayed, where the maximum efficiency ROI curve comprises a range of ROI values resulting from the set of media portfolio input characteristics. A user provides a prospective quantitative change to alter the media portfolio input characteristics in the media portfolio. The output response of the media portfolio to the prospective change is modeled, and suggested media plan reallocation values are displayed. In some embodiments, the prospective change is a spending or spending allocation change. In some embodiments, the prospective change is a user price change. An ROI value resulting from the prospective set of media portfolio input characteristics is displayed in juxtaposition to the maximum efficiency ROI curve.

Further details of aspects, objectives, and advantages of the disclosure are described below and in the detailed description, drawings, and claims. Both the foregoing general description of the background and the following detailed description are exemplary and explanatory, and are not intended to be limiting as to the scope of the claims.

### BRIEF DESCRIPTION OF THE DRAWINGS

FIG. 1A depicts a user interaction environment for forecasting and displaying results of resource allocations in a marketing campaign, according to some embodiments.

FIG. 1B shows efficiency curves plotted in an interactive interface used in forecasting and displaying results of resource allocations in a marketing campaign, according to some embodiments.

FIG. 1C shows reallocation values plotted in an interactive interface used in forecasting and displaying results of resource allocations in a marketing campaign, according to some embodiments.

FIG. 2 depicts a configuration screen used in a system for forecasting and displaying results of resource allocations in a marketing campaign, according to some embodiments.

FIG. 3A is a block diagram of a subsystem for precalculating efficient frontier data as used in systems for forecasting and displaying results of resource allocations in a marketing campaign, according to some embodiments.

FIG. 3B depicts a stimulus-response curve characterizing saturation behavior as used in systems for forecasting and displaying results of resource allocations in a marketing campaign, according to some embodiments.

FIG. 3C depicts a stimulus-response curve characterizing slow uptake behavior as used in systems for forecasting and displaying results of resource allocations in a marketing campaign, according to some embodiments.

FIG. 3D depicts a data flow for an efficient frontier algorithm as used in systems for forecasting and displaying results of resource allocations in a marketing campaign, according to some embodiments.

FIG. 4 depicts improved multi-channel responses to apportioning stimulus across multiple channels as used in systems for forecasting and displaying results of resource allocations in a marketing campaign, according to some embodiments.

FIG. 5 is a block diagram of a subsystem for precalculating exhaustive apportioner data as used in systems for forecasting and displaying results of resource allocations in a marketing campaign, according to some embodiments.

FIG. 6 shows reallocation values plotted in proximity to efficiency curves in an interactive interface as used in forecasting and displaying results of resource allocations in a marketing campaign, according to some embodiments.

FIG. 7 shows reallocation of resources across channels using slider bars in an interactive interface as used in forecasting and displaying results of resource allocations in a marketing campaign, according to some embodiments.

FIG. 8 is a block diagram of a system for displaying results of resource allocations in a marketing campaign, according to some embodiments.

FIG. 9 depicts a block diagram of an instance of a computer system suitable for implementing an embodiment of the present disclosure.

### DETAILED DESCRIPTION

### Overview

A modern marketing and advertising campaign involves many channels (e.g., TV, radio, newspaper, web, etc.) and each channel is selected by a marketing manager to achieve a particular objective (e.g., brand recognition, lead generation, etc.). Spending or other activity in one channel (e.g., placement of TV spots, placement of radio spots, etc.) can be increased to create an increased marketplace response. In some cases, spending in one channel can produce responses in other channels. A marketing manager might include many such channels in a media portfolio, and might apportion a media spend budget across the channels in a media portfolio. In some cases additional spending or changes to the extent or intensity of any forms of input characteristics of the media plan might reach a “saturation point” and might not produce any additional desired effects. For example, additional or different inputs (e.g., more advertising buys, and/or sending out more direct mail circulars, and/or reducing end-user pricing, and/or changing brand-awareness programs, etc.) may not produce any further responses.

A modern marketing and advertising campaign might involve inter-related channels, and the effects of increasing (or decreasing) spend in one channel may impact other channels, and the impacted channels may impact other channels, and so on. Especially in the face of such complexity, a marketing manager would want to know how to efficiently apportion their budgets across the channels in their marketing portfolio. Legacy approaches fail to sufficiently aid the marketing manager to find efficient spending mixes. Further, a marketing manager may not have complete flexibility of apportioning spend in a fully-optimized manner. For example, a marketing manager may be contractually bound to spend a certain amount within a certain time period. Legacy approaches fail to aid the marketing manager in evaluating variations from an optimal mix, even though is it common that a marketing manager is subject to constraints such as the aforementioned contractual obligations.

Still more, a marketing manager would need to quickly evaluate many variations in the characteristics of the media plan (e.g., changes in or combinations of spending, media allocation, end-user pricing, etc.). Unfortunately, recalculation of mixes of portfolio spending using legacy techniques are deficient in at least that legacy techniques are too slow and that legacy models are overly simplified models.

Techniques to interactively display marketing campaign predictions (e.g., revenue changes, changes in the number of inquiries, etc.) resulting from a particular mix of spending and/or resulting from a particular set of media plan characteristics of a media plan are needed. Furthermore techniques for displaying predictions resulting from a particular reallocation of spending in a media portfolio are needed.

### Sample Use Model

When defining a marketing and advertising campaign, many channels (e.g., for carrying out marketing and advertising activities) might be considered in a certain mix and/or schedule. For example, an advertising campaign might include a direct mail campaign followed by two weeks of radio spots, and followed by point-of-purchase coupons or other promotion for the product or service being advertised.

In such a scenario, and in other more complex scenarios, an advertiser would want to predict how increasing spending on one or another channel would affect the overall effectiveness of the campaign. The effect of increasing spending on one or another channel has long been studied, and legacy models quantify the effect of increasing spending on one or another channel in terms of measurable results. For example, if 1000 coupons were mailed to 1000 households, and those coupons resulted in 40 coupon redemptions for product purchases, the cost (or “investment”) of prosecuting the coupon portion of the campaign can be measured as a return on investment.

Legacy techniques predict future performance of a particular marketing activity based on past performance of that particular marketing activity. However, modern advertising campaigns often include activities in multiple channels (e.g., direct mail, radio, TV, etc.), some of which channels interact with other channels in complex ways. Legacy techniques fail to account for intra-channel phenomenon such as saturation (e.g., listeners get tired of hearing the same advertisement, and “tune out”) and for extra-channel phenomenon such as cross-channel effects (e.g., a direct mail coupon will receive more responses if mailed one week after a blitz of radio spots). Further, certain channels have natural and/or policy constraints and/or other constraints. For example, there are only a finite number of spots available for a TV ad on the “Evening News”.

### DEFINITIONS

Some of the terms used in this description are defined below for easy reference. The presented terms and their respective definitions are not rigidly restricted to these definitions—a term may be further defined by the term's use within this disclosure.
The term “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion.
As used in this application and the appended claims, the term “or” is intended to mean an inclusive “or” rather than an exclusive “or”. That is, unless specified otherwise, or is clear from the context, “X employs A or B” is intended to mean any of the natural inclusive permutations. That is, if X employs A, X employs B, or X employs both A and B, then “X employs A or B” is satisfied under any of the foregoing instances.
The articles “a” and “an” as used in this application and the appended claims should generally be construed to mean “one or more” unless specified otherwise or is clear from the context to be directed to a singular form.

Reference is now made in detail to certain embodiments. The disclosed embodiments are not intended to be limiting of the claims.

### DESCRIPTIONS OF EXEMPLARY EMBODIMENTS

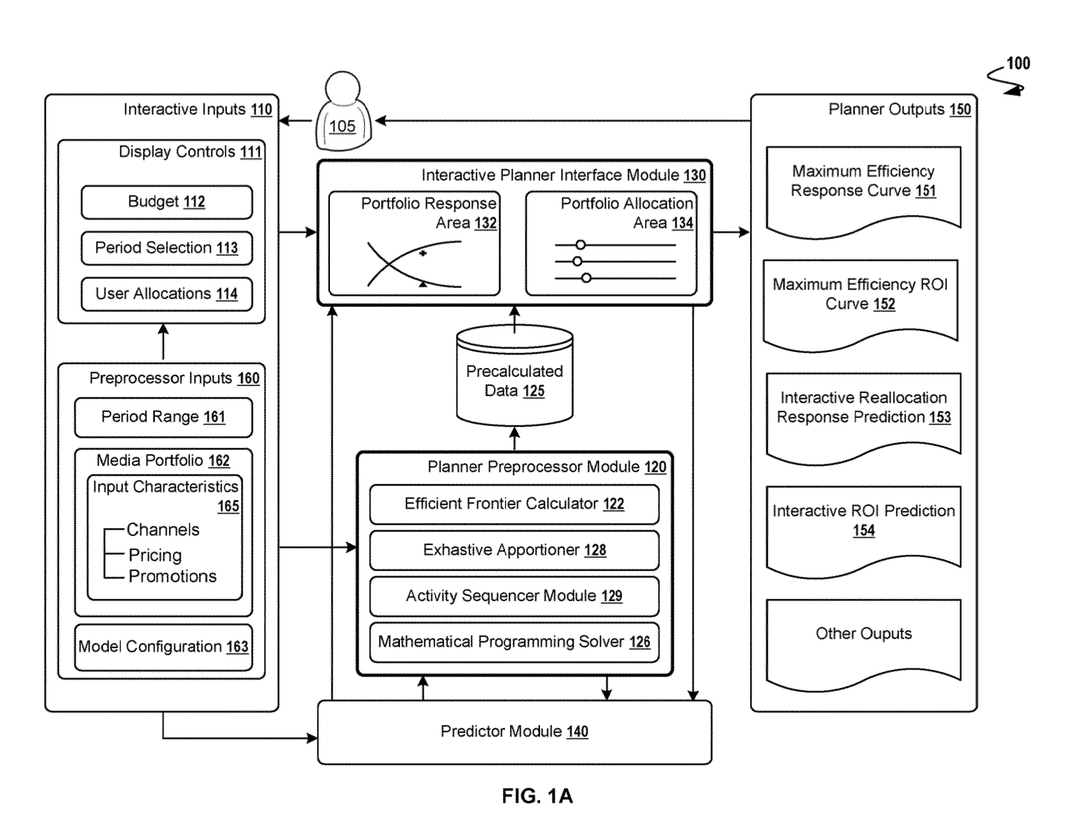

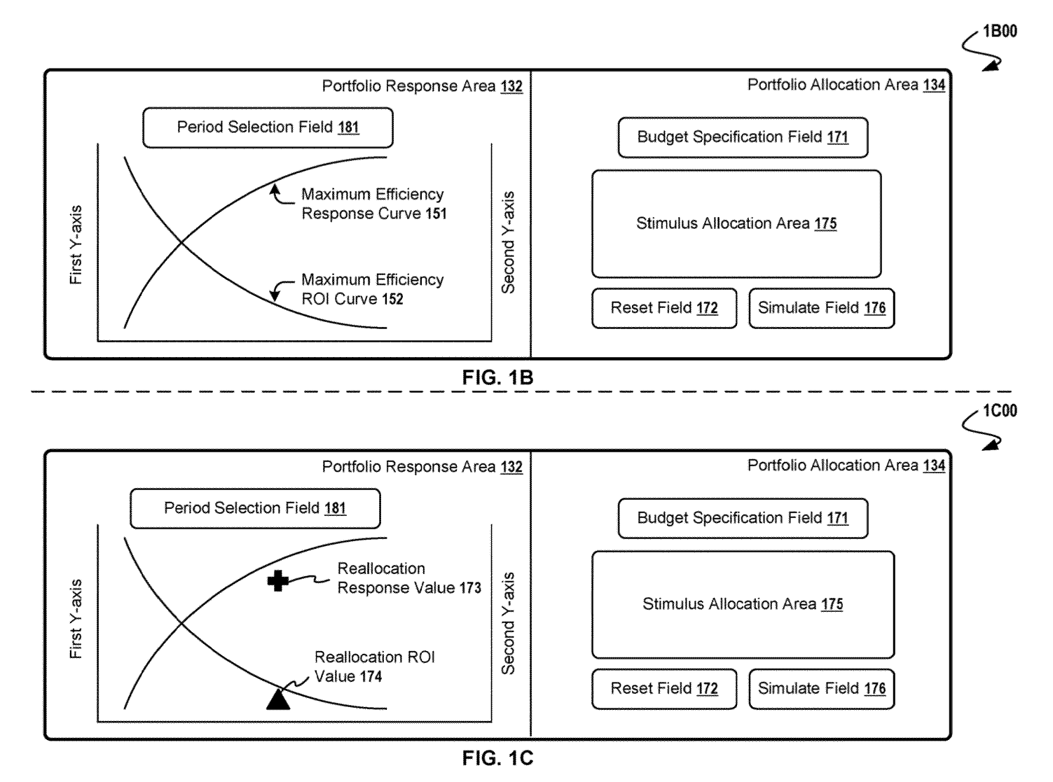

FIG. 1A depicts a user interaction environment 1A00 for forecasting and displaying results of resource allocations in a marketing campaign. As an option, one or more instances of environment 1A00 or any aspect thereof may be implemented in the context of the architecture and functionality of the embodiments described herein.

As shown, a user 105 interacts with an interactive planner interface module 130 using various screen devices (e.g., text boxes, sliders, pull-downs, widgets, etc.) that serve to capture interactive inputs 110. The interactive planner interface module 130 comprises a portfolio allocation area 134 and a portfolio response area 132. The user can use sliders or other widgets to vary any one or more media plan characteristics. For example, the user can use sliders or other widgets to vary media portfolio input characteristics 165 of the user's media portfolio. As another example, the user can use sliders or other widgets to allocate stimulus, set spending levels, define end-user pricing, define promotions, etc. or vary any other input characteristics 165 of the user's media portfolio 162 and/or of any other aspects of the user's media plan. In some cases, the user can use sliders or other widgets to model user response to any one or more media plan characteristics.

The efficacy of a particular apportionment to components in a portfolio can be predicted by sending the details of the particular apportionment to a predictor module 140, which in turn returns the predicted market response to the particular apportionment. As depicted, the predictor module uses a learning model that is trained on historical data. Further details pertaining to the learning model can be found in U.S. Application No. (Attorney Docket No. VISQ.P0004), entitled “Media Spend Optimization Using Cross-Channel Predictive Model”, Inventors Anto Chittilappilly, Payman Sadegh and Darius Jose, filed Dec. 31, 2013, which is expressly incorporated herein by reference. The learning model can incorporate end-user responses to any sorts of values or changes in the media plan, including without limitation values or changes to product pricing, values or changes to channel spend, values or changes to advertising material, radio spot copy, etc., and can predict market response(s) from any one or more of the aforementioned values or changes.

In addition to presenting a predicted market response to a particular apportionment (e.g., in the form of curves plotting a response as a function of stimulus), the interactive planner interface module 130 can produce various planner outputs 150, which can comprise any forms of output (e.g., displayed curves, tables, reports, etc.) and can include a maximum efficiency response curve 151, a maximum efficiency ROI curve 152, an interactive reallocation response prediction 153, and/or an interactive ROI prediction 154.

The aforementioned predictor module can operate in an interactive setting (e.g., in cooperation with interactive planner interface module 130) and/or in an offline or batch mode (e.g., in cooperation with a planner preprocessor module 120). A planner preprocessor module 120 can perform batch processing that results in storage of precalculated data 125, which in turn can be used by an interactive planner interface module 130. In particular, a query or scenario can be formed by a user, input into the interactive planner interface module 130, and through use of the precalculated data 125, the interactive planner interface module can return results interactively (e.g., without closing the screen or application). The precalculated data 125 can result from any one or more of various modules within the planner preprocessor module. Strictly as an illustrative example, the planner preprocessor module comprises:
An efficient frontier calculator 122;
An exhaustive apportioner 128;
An activity sequencer module 129;
A mathematical programming solver 126.

The planner preprocessor module 120 can be configured to receive preprocessor inputs 160 that correspond to various user-specified ranges and/or selections used to calculate and output precalculated data 125. For example, a user might specify a period range 161 over which the user intends to prosecute the media campaign. The user can specify various channels or other characteristics of a media portfolio 162, and a user can specify a model configuration 163.

Using such a model configuration, the predictor module can produce predictions as to how the media portfolio would respond to various stimuli. For example, using the selected model configuration, the predictor module can predict a response or responses (e.g., an increase of sales, an increase of inquiries, etc.) to a particular stimulation (e.g., an increase in spending, or a reapportionment of the budget, etc.).

Further configurations can be specified by a user. For example, a screen device for presenting and capturing interactive inputs 110 can comprise display controls 111 that alter the look-and-feel and presentations on the screen. Such display controls can include presentation and capturing aspects of a budget 112 (e.g., a preferred currency), a period selection 113 (e.g., days, weeks, months, quarters, etc.), and/or user allocations 114 (e.g., default user allocations).

A selection of techniques for interacting with a user are shown and discussed as pertaining to FIG. 1B and other figures below. In exemplary cases, the portfolio response area 132 is populated by default with one or more maximum efficiency response curves and one or more maximum efficiency ROI curves.

FIG. 1B shows efficiency curves plotted in an interactive interface 1B00 used in forecasting and displaying results of resource allocations in a marketing campaign. As an option, one or more instances of interactive interface 1 B00 or any aspect thereof may be implemented in the context of the architecture and functionality of the embodiments described herein. Also, the interactive interface 1B00 or any aspect thereof may be implemented in any desired environment.

As shown, the interactive interface 1B00 comprises a portfolio allocation area 134 and a portfolio response area 132. The portfolio allocation area 134 can comprise a container that includes:
A budget specification field 171 to receive user input as to a maximum spend;
A stimulus allocation area 175 to receive from a user an allocation (e.g., a spend value or a percentage value) that apportions an amount of spend or percentage of spend to a set of media portfolio constituents (e.g., media channels);
A reset button or reset field 172 to reset apportionments to a default values or initial state values; and
A simulate button or simulate field 176 to launch a simulation or calculation of a predicted portfolio response.

The predicted portfolio response can be displayed in a portfolio response area 132. The data displayed in the portfolio response area (e.g., a maximum efficiency response curve 151, a maximum efficiency ROI curve 152) can be plotted on an XY plot (as shown), and the display can be manipulated using a period selection field 181 and/or a scrollbar or scroll wheel or other scroll control or other known-in-the-art manipulation techniques. Multiple Y-axis scales can be presented in the graphs shown in the portfolio response area.

Those skilled in the art will recognize that a maximum efficiency response curve can be calculated for a media portfolio, and can be displayed even in the absence of a budget specification. An optional budget specification (e.g., as provided in the budget specification field 171) can be plotted in the portfolio response area (e.g., as a vertical line).

As earlier indicated, the stimulus allocation area can receive from a user an allocation (e.g., a spend value or a percentage value) that apportions an amount of spend or percentage of spend to a set of media portfolio constituents (e.g., media channels), and the given apportionment can be simulated on demand (e.g., upon user indication via the simulate field 176). The results of the simulation (e.g., using a specific budget and a specific apportionment of media spends) can be plotted on or near the curves in the portfolio response area. The user can reallocate and simulate any number of times. For each iteration, the results of the simulation are plotted on or near the curves in the portfolio response area as reallocation values.

FIG. 1C shows reallocation values plotted in an interactive interface 1C00 used in forecasting and displaying results of resource allocations in a marketing campaign. As an option, one or more instances of interactive interface 1 C00 or any aspect thereof may be implemented in the context of the architecture and functionality of the embodiments described herein. Also, the interactive interface 1 C00 or any aspect thereof may be implemented in any desired environment.

As shown, interactive interface 1 C00 comprises a reallocation response value 173 and a reallocation ROI value 174. As earlier indicated, exemplary embodiments populate the portfolio response area with a maximum efficiency response curve and a maximum efficiency ROI curve. A reallocation response value 173 and a reallocation ROI value 174 can be plotted on or near the maximum efficiency response curve and on or near the maximum efficiency ROI curve, respectively, and as shown.

The budget can be changed and/or the allocation can be changed, and the scenario can be re-simulated. After re-simulation, a new reallocation response value is plotted and a new reallocation ROI value is plotted.

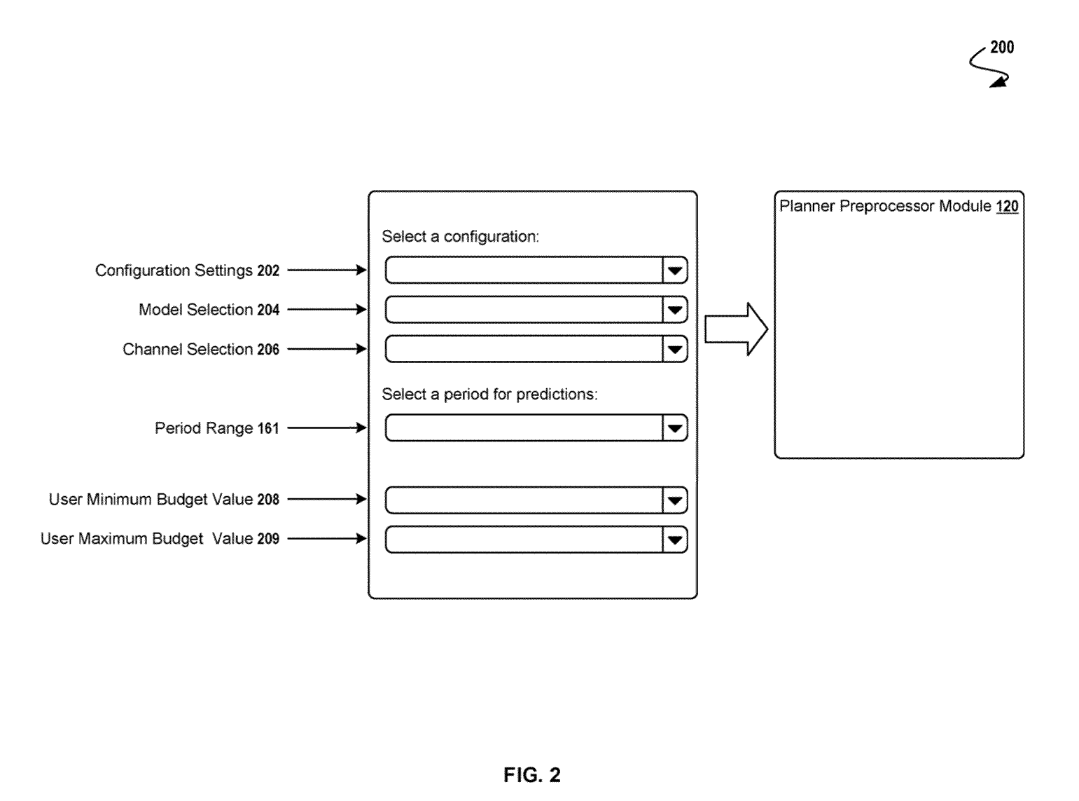

FIG. 2 depicts a configuration screen 200 used in a system for forecasting and displaying results of resource allocations in a marketing campaign. As an option, one or more instances of configuration screen 200 or any aspect thereof may be implemented in the context of the architecture and functionality of the embodiments described herein. Also, the configuration screen 200 or any aspect thereof may be implemented in any desired environment.

As shown, the configuration screen 200 supports defining various types of configuration settings 202. For example, configuration screen 200 supports a user interface to define a model and/or model configurations to be used by the predictor module (e.g., see model selection 204). In this embodiment, once a model has been selected then channels used in the model can be selected (see channel selection 206). A time period over which simulations are performed and/or results are calculated can be defined (see period range 161).

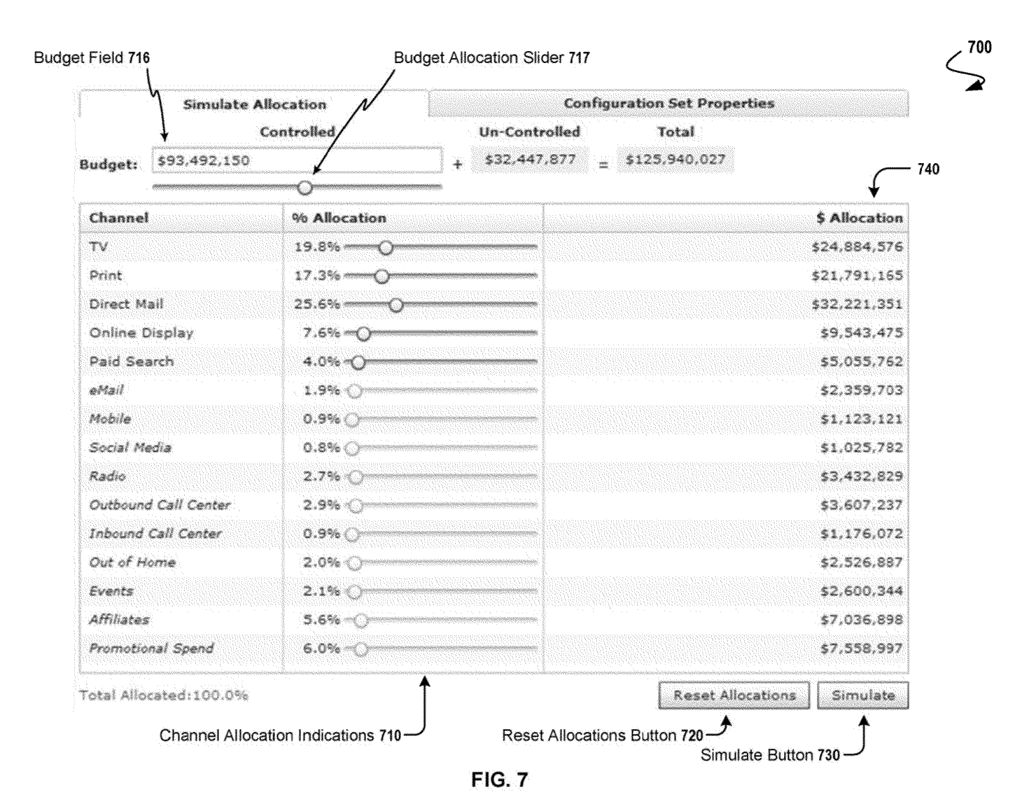

In exemplary embodiments, the configuration settings are interpreted as follows:
The configuration settings 202 define the base configuration for which a yield curve is generated.
The period range 161 includes a definition of a prediction period for which the yield curve is generated.
The channel selection 206 can be implemented as a multi-value channel drop-down from which channels can be highlighted or otherwise selected. The selected channels can be represented as channel allocation sliders such as, for example, in the portfolio allocation area 134 (see FIG. 1A).
A minimum budget and maximum budget can be established using a user minimum budget value 208 and a user maximum budget value 209. Budgets are used in calculations and are displayed for user interaction. Budgets are further discussed below (e.g., see FIG. 7).

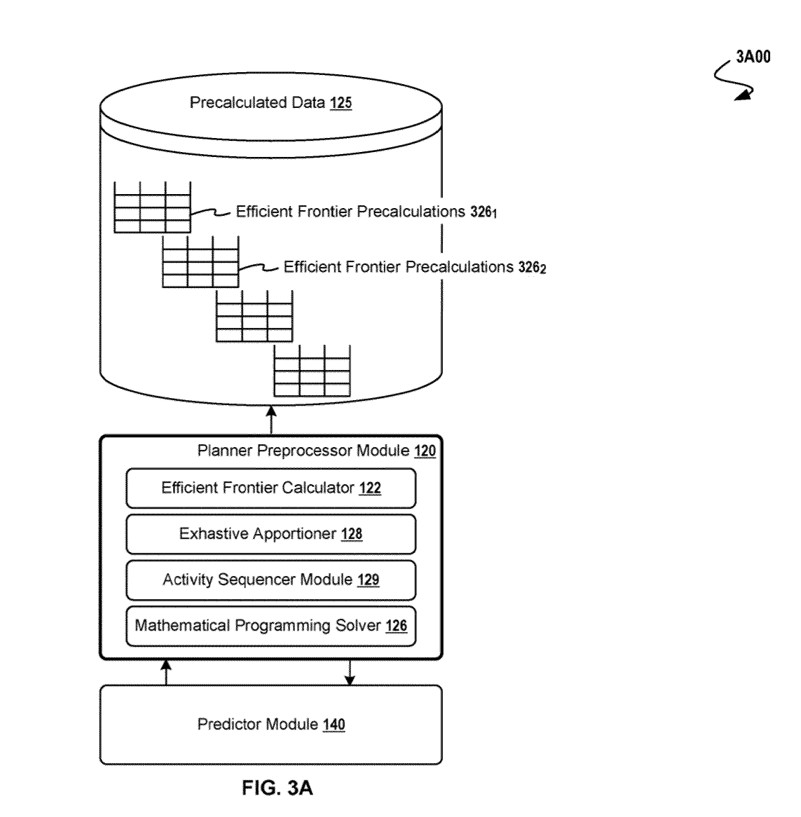

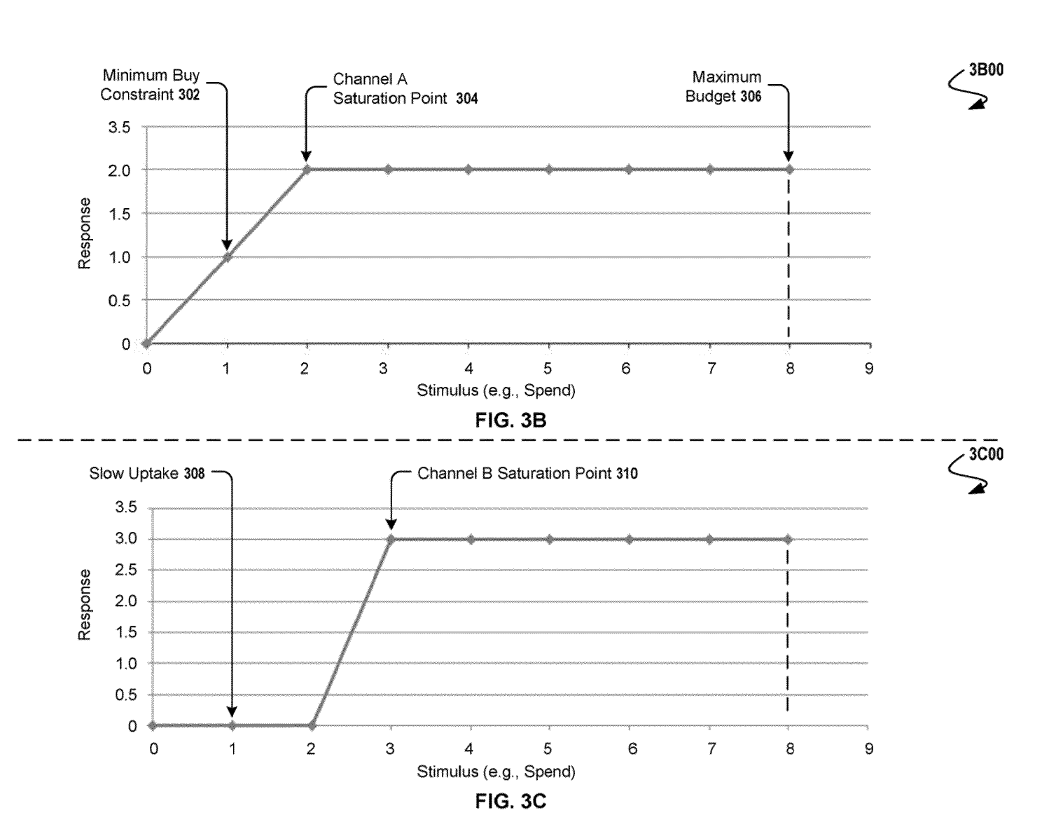

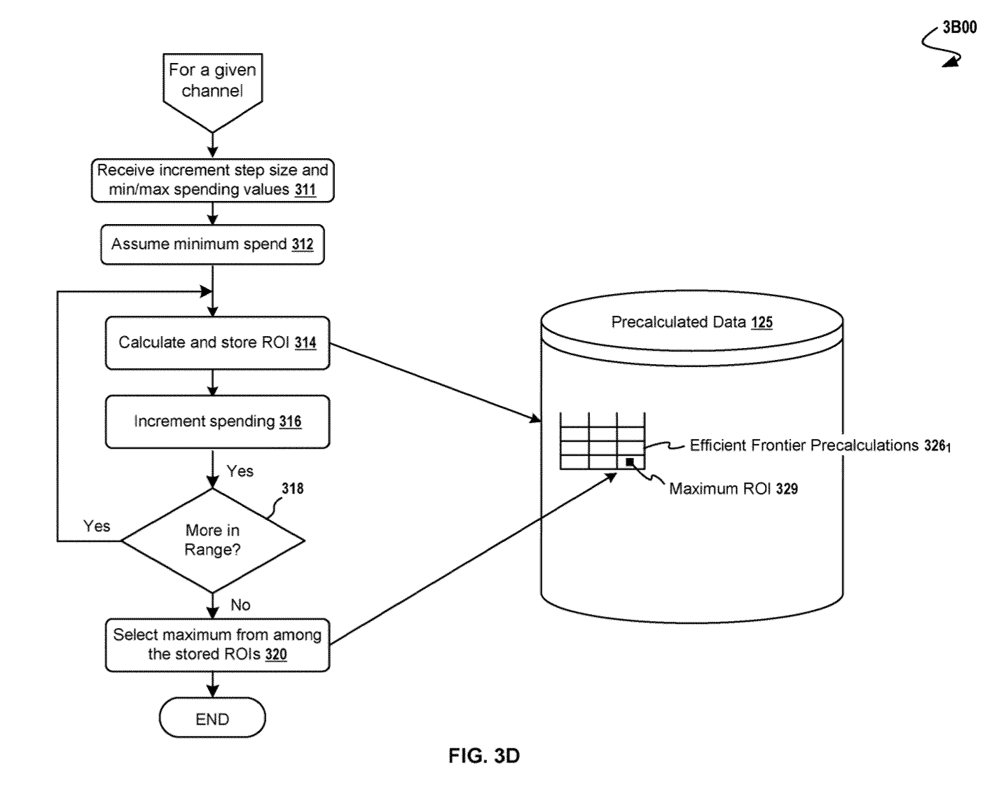

FIG. 3A is a block diagram of a subsystem 3A00 for precalculating efficient frontier data as used in systems for forecasting and displaying results of resource allocations in a marketing campaign. As an option, one or more instances of subsystem 3A00 or any aspect thereof may be implemented in the context of the architecture and functionality of the embodiments described herein. Also, the subsystem 3A00 or any aspect thereof may be implemented in any desired environment.

As shown, the planner preprocessor module 120 comprises an efficient frontier calculator 122 and an exhaustive apportioner 128. Any of the constituent components of the planner preprocessor module can perform calculations, and can store results of such calculations in a storage location (e.g., precalculated data 125). The storage location can contain any organization of data, including tables, possibly in the form of one or more instances of precalculations (e.g., efficient frontier precalculations 326₁, efficient frontier precalculations 326₂, etc.).

The planner preprocessor module interfaces with the shown predictor module 140, which in turn comprises a model (e.g., the model selected using configuration screen 200). The efficient frontier calculator can use the predictor module to determine a level of stimulus for each channel up until the response in the respective channel does not yield better results (e.g., when the channel does not yield additional increased response). Or, in some cases, the planner preprocessor module can use the predictor module to determine a level of stimulus for each channel up until the first derivative of the response goes to zero or turns negative. In such situations, the channel is considered to exhibit saturation behavior.

FIG. 3B depicts a stimulus-response curve 3B00 characterizing saturation behavior as used in systems for forecasting and displaying results of resource allocations in a marketing campaign.

The curve shows a response as a function of stimulus (e.g., spending). In the specific example shown, initially the response increases linearly with spending until a saturation point is reached, after which even increased spending does not show an increase in response. This is deemed a saturation point (e.g., see Channel A saturation point 304).

In some scenarios, spending might be constrained. For example, spending might be constrained (e.g., by the channel) for a minimum buy constraint 302, and/or spending might be constrained with a maximum budget 306. In a case such as is depicted, since the maximum budget is larger than the saturation point, a marketing manager might want to spend the budget in other channels. Channel B is such a channel. In this specific example, the shown Channel B exhibits a slow uptake.

FIG. 3C depicts a stimulus-response curve 3C00 characterizing slow uptake behavior as used in systems for forecasting and displaying results of resource allocations in a marketing campaign.

As shown, one unit of spending has zero response, and two units of spending also has zero response. However, three units of spending yields a non-zero response. This behavior is deemed as a slow uptake over the range of zero response from non-zero spending (see slow uptake 308). Channel B also exhibits a saturation point (e.g., see channel B saturation point 310).

The behavior as depicted in the foregoing FIG. 3A and FIG. 3B may be captured in a model, and such a model may be formed from measurements of spending in a channel and measurements to quantify the response of the spending. In many cases, many channels are combined in a marketing program, and a marketing manager would want to know how to apportion the budget across the constituent channels in the marketing program. One technique to apportion spending or other stimulus over a plurality of channels in a marketing program is to apportion based on an efficient frontier. Spending in accordance with an efficient frontier seeks to apportion additional spending in a channel only until the spending begins to produce diminishing returns. One algorithm for calculating an efficient frontier for a marketing plan with multiple channels is presently discussed.

FIG. 3D depicts a data flow 3D00 for an efficient frontier algorithm as used in systems for forecasting and displaying results of resource allocations in a marketing campaign. As an option, one or more instances of data flow 3D00 or any aspect thereof may be implemented in the context of the architecture and functionality of the embodiments described herein. Also, the data flow 3D00 or any aspect thereof may be implemented in any desired environment.

The flow used for generating the efficient frontier data can be configured with values for:
A minimum controllable spend (e.g., a sum of all minimum buy constraints for each used channel);
A maximum controllable spend point (e.g., a budget); and
An increment step size.

As shown, the data flow 3D00 is executed iteratively over each channel to be considered in the marketing campaign. Initially, the processing receives a spending increment step size and minimum and maximum spending values (see operation 311), and assumes an initial spending amount (e.g., the minimum spending amount) pertaining to the given channel (see operation 312). The response of the spending is determined (e.g., using a predictor module). The return (ROI) is calculated and stored (see operation 314). The amount specified as the aforementioned step size is allocated to spending (see operation 316) and calculated and stored (again, see operation 314). A decision 318 determines if the loop is to be executed again (e.g., with an increment of step size) and so long as there is more spending possible (e.g., there is more budget available) the ROI for that spending level is determined and stored. After the responses over the determined stimulus have been calculated and the corresponding ROI has been calculated, the set of stored ROI values is checked. The spending level returning the maximum ROI 329 is deemed to be at the efficient frontier (see selection of operation 320).

The data flow 3D00 is iterated over all channels in a portfolio. Table 1 shows the results of executing data flow 3D00 over three channels (e.g., CH1, CH2, and CH3). The bolded numbering in Table 1 depicts the occurrence of increasing ROI as the spending is increased according the quanta step size.

TABLE 1
Efficient frontier calculation

| CH1 | CH1 | CH2 | CH2 | CH3 | CH3 |
|---|---|---|---|---|---|
| Increasing | Frontier | Increasing | Frontier | Increasing | Frontier |
| Spending | Amount | Spending | Amount | Spending | Amount |
| 200000 | | 85000 | | 1000000 | |
| 250000 | | 85000 | | 1000000 | |
| 300000 | | 85000 | | 1000000 | |
| 350000 | | 85000 | | 1000000 | |
| 400000 | | 85000 | | 1000000 | |
| 450000 | | 85000 | | 1000000 | |
| 500000 | 500000 | 85000 | | 1000000 | |
| 500000 | | 135000 | | 1000000 | |
| 500000 | | 185000 | 185000 | 1000000 | |
| 500000 | | 185000 | | 1050000 | |
| 500000 | | 185000 | | 1100000 | Not found within |
| | | | | | remaining budget |

Combining these results produces a curve depicting the most ‘yield to spend’ ratio. Channel effects such as saturation are incorporated into the resulting ‘yield to spend’ ratio curve. In some cases, the foregoing efficient frontier calculations are stored as precalculated data 125 for later retrieval.

It should be noted that the data flow 3D00 is merely one technique to calculate an efficient frontier. And, it should be noted that the application of the aforementioned efficient frontier algorithm over all channels in a portfolio does not necessarily result in an optimal allocation. In some cases spending at efficient frontier levels exceeds the maximum budget, and in some cases the selection of a first channel over which to iterate affects later results, and in some cases the selection of a first channel can prevent identification of any optimal allocation result. In some such cases (e.g., under user control), and to avoid some or all of the aforementioned shortcomings of an iterative approach to calculating an efficient frontier, an exhaustive search algorithm might be run to see if the efficient frontier points can be beaten (e.g., to give a better yield than iteratively-calculated efficient frontier points).

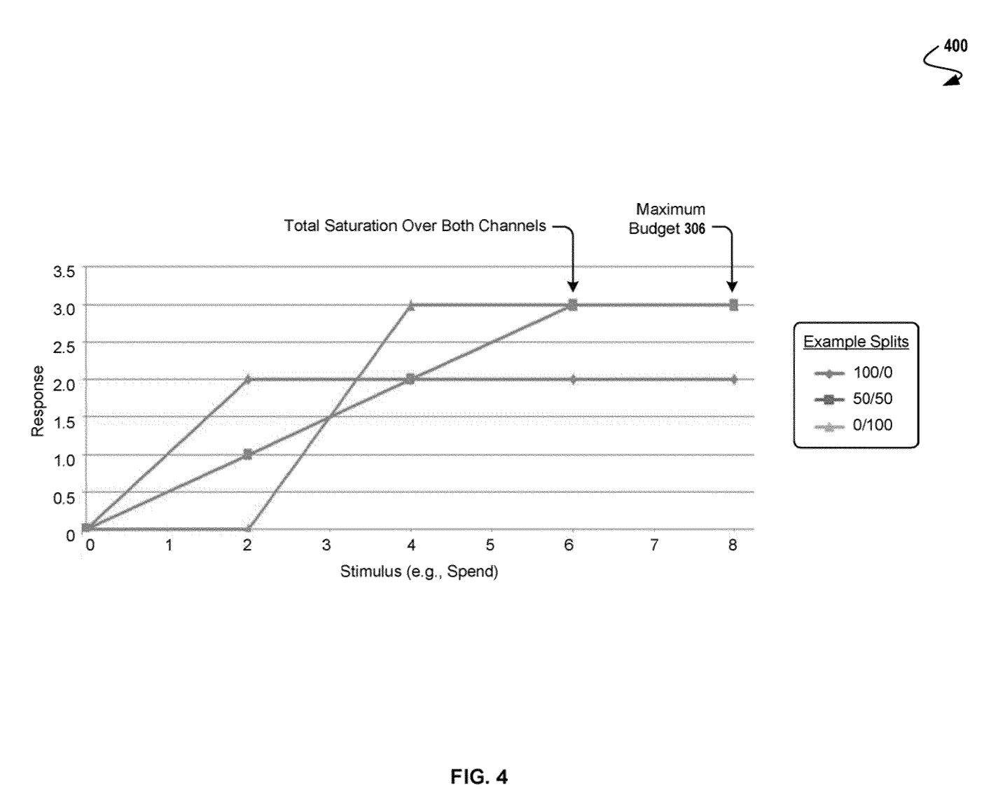

FIG. 4 depicts improved multi-channel responses 400 to apportioning stimulus across multiple channels as used in systems for forecasting and displaying results of resource allocations in a marketing campaign. As an option, one or more instances of improved multi-channel responses 400 or any aspect thereof may be implemented in the context of the architecture and functionality of the embodiments described herein. Also, the improved multi-channel responses 400 or any aspect thereof may be implemented in any desired environment.

Returning to the discussion of FIG. 3B and FIG. 3C, and further considering the above-described efficient frontier algorithms, an efficient spending amount for Channel A would be (as shown) “2” (the point beyond which further spending does not yield an increased response). Also, an efficient spending amount for Channel B would be (as shown) “4” (the point beyond which further spending does not yield an increased response). Still further, it can be seen in this example that the efficient spending frontier {“2” in Channel A, and “4” in Channel B} produces better results than splitting the budget equally over the two channels.

Now, even though the specific given efficient spending frontier {“2” in Channel A, and “4” in Channel B} produces better results than splitting the budget over the two channels, there may be cross-channel effects that are present, yet are not taken into account in embodiments of the efficient spending algorithms.

In such cases better outcomes can be achieved by apportioning spending variously to different channels (e.g., to take advantage of cross-channel effects). And, in some cases, an optimal spending amount can be determined using a known-in-the-art optimizer. Such an optimizer is depicted as a mathematical programming solver 126.

In certain cases, a mathematical programming solver is not convenient to use (e.g., when the complete description of the problem to be optimized and/or the constraint set is not fully quantified). Yet, per-channel improved apportioned spending (e.g., a spending amount per channel) can be determined using an exhaustive apportioner 128. In some cases an exhaustive set of scenarios can be calculated in real time. In other cases (e.g., when the number of channels is large and/or when the extent of the data set is large) it may be convenient to run a large number of scenarios and store the results as precalculated data 125 for later retrieval.

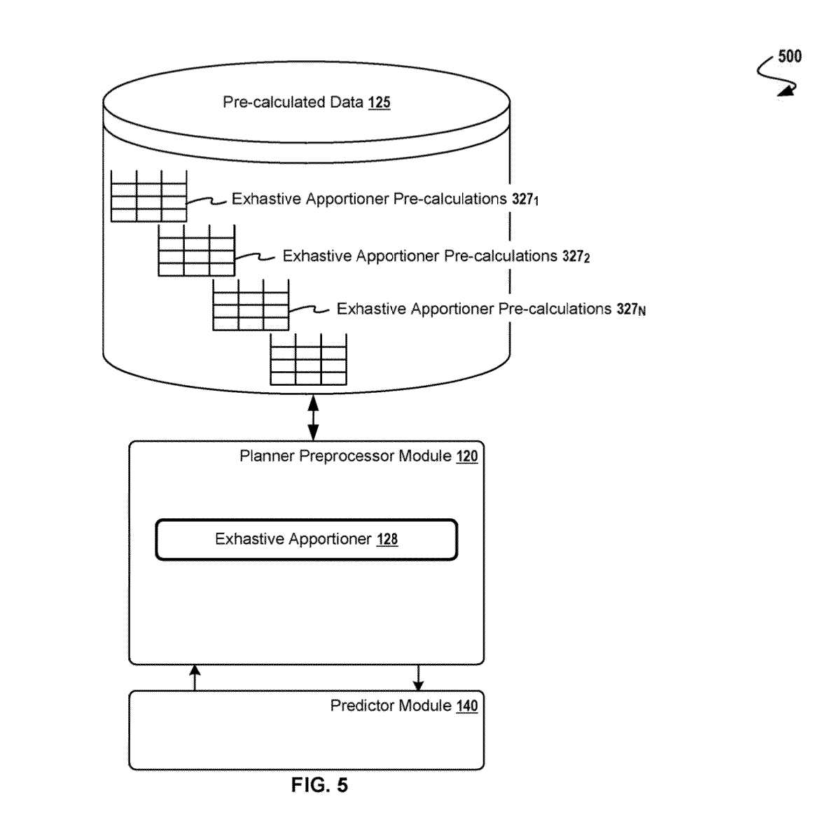

FIG. 5 is a block diagram of a subsystem 500 for precalculating exhaustive apportioner data as used in systems for forecasting and displaying results of resource allocations in a marketing campaign. As an option, one or more instances of subsystem 500 or any aspect thereof may be implemented in the context of the architecture and functionality of the embodiments described herein. Also, the subsystem 500 or any aspect thereof may be implemented in any desired environment.

As earlier indicated, an efficient frontier for spending can be calculated using a repetitive process of allocating a fixed amount onto individual spends based on maximum yield. This technique includes the effect that the newly generated points on the frontier are based on previous points. Under a condition of a budget, the selection of which channel to consider first, and second, and so on can have a dramatic effect on the shape of the overall efficient frontier.

An exhaustive search algorithm can serve to overcome this limitation. Such an exhaustive search algorithm can proceed by testing all possible combinations and report a channel-by-channel spending recommendation. If and when the newly generated spend recommendations are improved over the former efficient frontier calculations (if any), then the improved spending values can be used to form a maximum efficiency response curve 151 and to form a corresponding maximum efficiency ROI curve 152.

It might occur that the computer processes for generating spend recommendations become compute-intensive. In such a case it might be expedient to save precalculated data. As shown, precalculated data 125 comprises various exhaustive apportioner precalculations (e.g., see exhaustive apportioner precalculations 327₁, exhaustive apportioner precalculations 327₂, exhaustive apportioner precalculations 327_{N}, etc.).

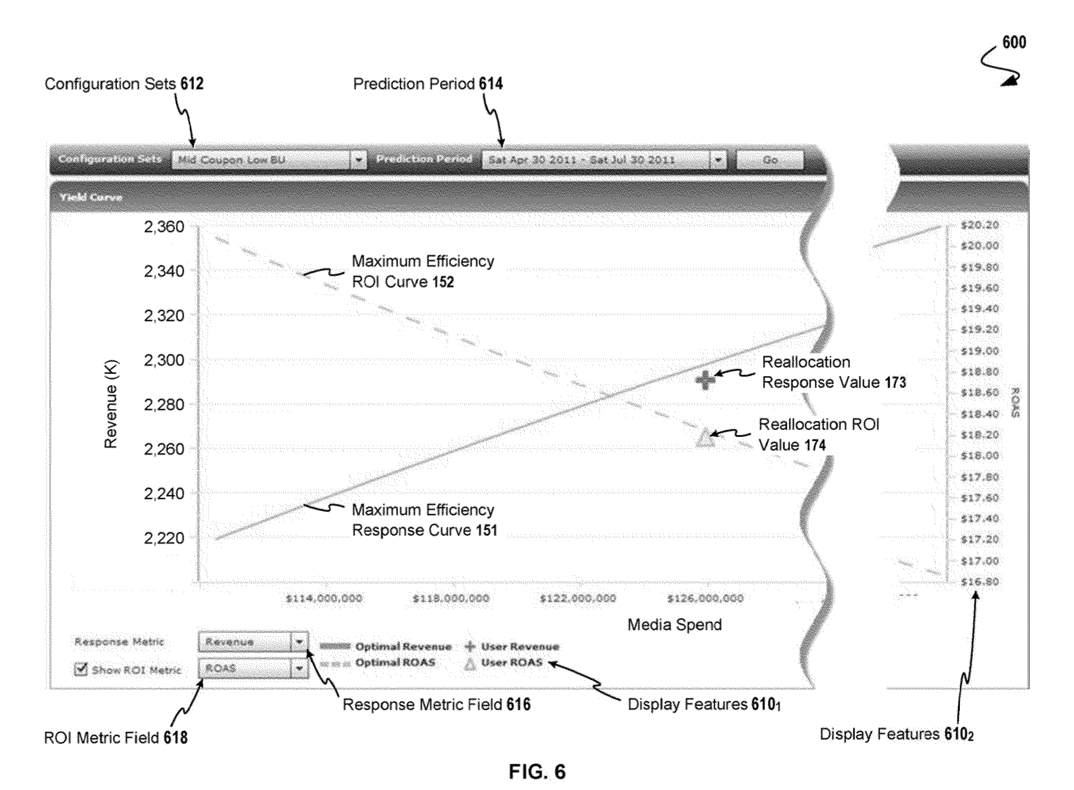

FIG. 6 shows reallocation values plotted in proximity to efficiency curves in an interactive interface 600 as used in forecasting and displaying results of resource allocations in a marketing campaign. As an option, one or more instances of interactive interface 600 or any aspect thereof may be implemented in the context of the architecture and functionality of the embodiments described herein. Also, the interactive interface 600 or any aspect thereof may be implemented in any desired environment.

A marketing manager might want to see an efficient spending curve (e.g., an efficient spending curve resulting from an efficient frontier calculation, or a curve or point generated by an exhaustive apportioner) and a marketing manager might want to see the apportioning of the spending. The marketing manager might also want to see the effects of adjustments to or mixes of the recommended spending. As earlier indicated, what is needed is a technique or techniques to interactively display marketing campaign predictions (e.g., revenue changes) resulting from a particular interactively-set allocation/reallocation of spending in a media portfolio.

The interactive interface 600 serves to provide an interface for a user to interactively-set allocation/reallocation of spending in a media portfolio and show reallocation values plotted in proximity to efficiency curves.

Strictly as one embodiment, the screen devices and their operation serve to address this need. In this specific embodiment, the following functions are shown and described:
A configuration set field 612 (see the label “Configuration Sets”) defines a particular configuration. Such a configuration set can result from user interaction with configuration screen 200.
A prediction period field 614 (see the prediction period combo box). A date or a date range can be provided in this field. The prediction period can fully overlap with a respective period covered by a learning model used by predictor module 140. Or, the prediction period can partially overlap with a respective period covered by a learning model used by predictor module 140. Or, the prediction period can cover a period that is fully outside of a respective period covered by a learning model use by predictor module 140.
A response metric field 616 (see combo box labeled “Response Metric”). As shown, the drop-down menu gives choices. The selection of a choice determines underlying calculations to be performed and determines characteristics of the curves to be displayed (e.g., see maximum efficiency response curve 151). The selection of a choice can also determine the dimension and scale of the left Y axis. Selecting an item in this combo box can further determine the dimensions of the right Y axis. Responsive to the selection, default curves can be displayed. For example, calculations can be performed and a curve display can be displayed (e.g., maximum efficiency ROI curve 152). Other forms of maximum efficiency curves can be calculated and displayed, some examples and display variations of which are described below.
An ROI metric field 618 (see combo box labeled “Show ROI Metric”) shows the dimension of the right Y axis. Selecting a different item in this box will switch the curve and its labels (and dimension and scale) to reflect the selection.
A show-hide checkbox. A user can toggle between showing or hiding the display features of a selected ROI metric. As depicted, the “Show ROI Metric” check box is checked and the display features (e.g., the shown display features 610₁ and display features 610₂, etc.) of the selected return on advertising spend “ROAS” appear on the interactive interface 600.
A reallocation response value 173. A screen device (e.g., a plus sign) displays a point corresponding to a user reallocation (see FIG. 7). A screen device corresponding to a reallocation response value 173 is shown proximally in relation to the maximum efficiency response curve 151.
A reallocation ROI value 174. A screen device (e.g., a triangle) displays a point corresponding to a user reallocation (see FIG. 7). A screen device corresponding to a reallocation ROI value 174 is shown proximally in relation to the maximum efficiency ROI curve 152.

As indicated in the foregoing, a user can reallocate spending or other stimulus across a plurality of channels. A user change in spending can be identified using screen devices (e.g., see the sliders of FIG. 7), and the predicted effects of such a reallocation can be simulated and displayed. Techniques for performing reallocations and for performing simulations are shown and described as pertaining to FIG. 7.

FIG. 7 shows reallocation of resources across channels using slider bars in an interactive interface 700 as used in forecasting and displaying results of resource allocations in a marketing campaign. As an option, one or more instances of interactive interface 700 or any aspect thereof may be implemented in the context of the architecture and functionality of the embodiments described herein. Also, the interactive interface 700 or any aspect thereof may be implemented in any desired environment.

The interactive interface 700 can be initialized to show default conditions and/or to show the apportionments across the channels of the portfolio that correspond to the channel-by-channel apportionment determined by an efficient frontier calculator or by an exhaustive apportioner module. By interacting with interactive interface 700 a user can reapportion spending over the channels in the media portfolio.

Specifically, and as shown, a user can enter a budget amount using a budget field 716 or by using a budget allocation slider 717. A default value for a budget can be determined via a calculation that chooses a mid-point between a user-defined minimum budget and user-define maximum budget. Such user-defined budget points can be defined in a configuration screen 200 (e.g., using a user minimum budget value 208 and user maximum budget value 209). Budget values can be referred to indirectly via the configuration set.

Responsive to a change in the budget amount, the system displays an allocation. The allocation can be displayed as a percent of the budget (e.g., using sliders or other screen devices to show an arrangement of channel allocation indications 710), or the allocation can be displayed in the units of the budget (e.g., in dollars, as shown in column 740). When user allocations have been established, the user can initiate activities that emulate a simulation (e.g., using precalculated data 125) or perform a simulation.

The emulation or simulation activities serve to determine or predict the effect that the user allocations would have on the response of the media portfolio as a whole. The effects can be plotted using a reallocation response value 173 and a reallocation ROI value 174. The emulation or simulation activities can be initiated at will by a user using the simulate button 730.

In some cases, a user might want to return the channel allocations to the channel-by-channel apportionment determined by an efficient frontier calculator or by an exhaustive apportioner module. In such a case, the user can interact with a screen device to reset allocation (e.g., using reset allocations button 720). The user can again adjust allocations and interact with a screen device to initiate simulation or emulation activities (e.g., using simulate button 730).

Returning to the discussion of user-defined budget values, it is possible for a user to indicate that a budget is “unknown”. In such a case, a default budget is determined. One approach to determining a default budget (e.g., a minimum budget) is to sum all of the minimum spend values as given through the entire portfolio, and use that value.

Any of a variety of known-in-the art techniques can be used to prevent unwanted overwriting of user values can be employed during user interaction.

### Sample Use Model

A use case proceeds a follows:
A user clicks on the reset allocations button 720 to reset the displayed values to depict values determined by an efficient frontier calculator or by an exhaustive apportioner module.
A user clicks on the simulate button 730. That action initiates activities to get response metric numbers for the combination of the total budget and channel allocations as specified by the user. If the total of all channel allocations do not sum up to 100%, the user is prompted to further reapportion spending percentages to reach 100%. The channel allocations can be reapportioned to total to 100% using any known technique.
A user interacts with one or more channel allocation indications 710 (e.g., using the per-channel budget allocation sliders). The shown interface supports channel allocation indications to be set to a value between the minimum budget and the maximum budget as defined in the configuration set.

Some embodiments support a display panel (see the tab labeled “Configuration Set Properties”). Such a display panel shows a read-only list of name-value strings describing the various facts about the selected configuration set over a selected prediction period.

### Additional Practical Application Examples

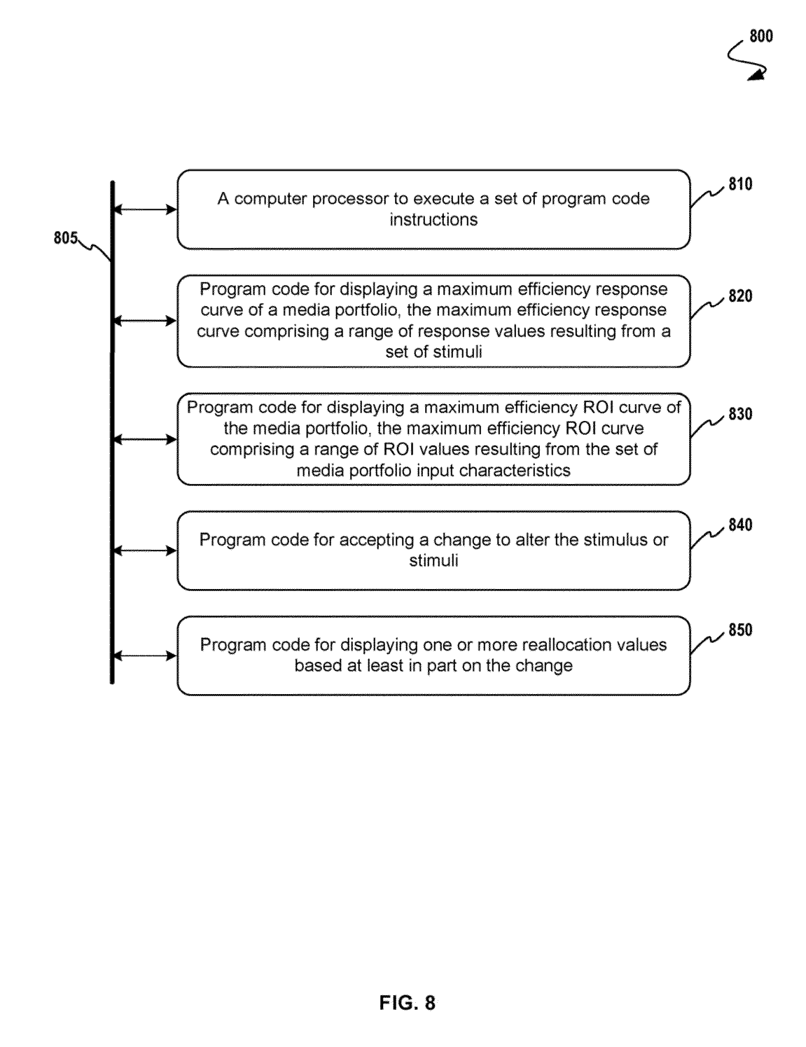

FIG. 8 is a block diagram of a system for displaying results of resource allocations in a marketing campaign, according to some embodiments. As an option, the present system 800 may be implemented in the context of the architecture and functionality of the embodiments described herein. Of course, however, the system 800 or any operation therein may be carried out in any desired environment.

As shown, system 800 comprises at least one processor and at least one memory, the memory serving to store program instructions corresponding to the operations of the system. As shown, an operation can be implemented in whole or in part using program instructions accessible by a module. The modules are connected to a communication path 805, and any operation can communicate with other operations over communication path 805. The modules of the system can, individually or in combination, perform method operations within system 800. Any operations performed within system 800 may be performed in any order unless as may be specified in the claims.

The embodiment of FIG. 8 implements a portion of a computer system, shown as system 800, comprising a computer processor to execute a set of program code instructions (see module 810) and modules for accessing memory to hold program code instructions to perform: displaying a maximum efficiency response curve of a media portfolio, the maximum efficiency response curve comprising a range of response values resulting from a set of stimuli (see module 820); displaying a maximum efficiency ROI curve of the media portfolio, the maximum efficiency ROI curve comprising a range of ROI values resulting from the set of media portfolio input characteristics (e.g., spending or other stimulus) (see module 830); accepting a change to alter the stimulus or stimuli (see module 840); and displaying one or more reallocation values based at least in part on the change (see module 850).

### Additional System Architecture Examples

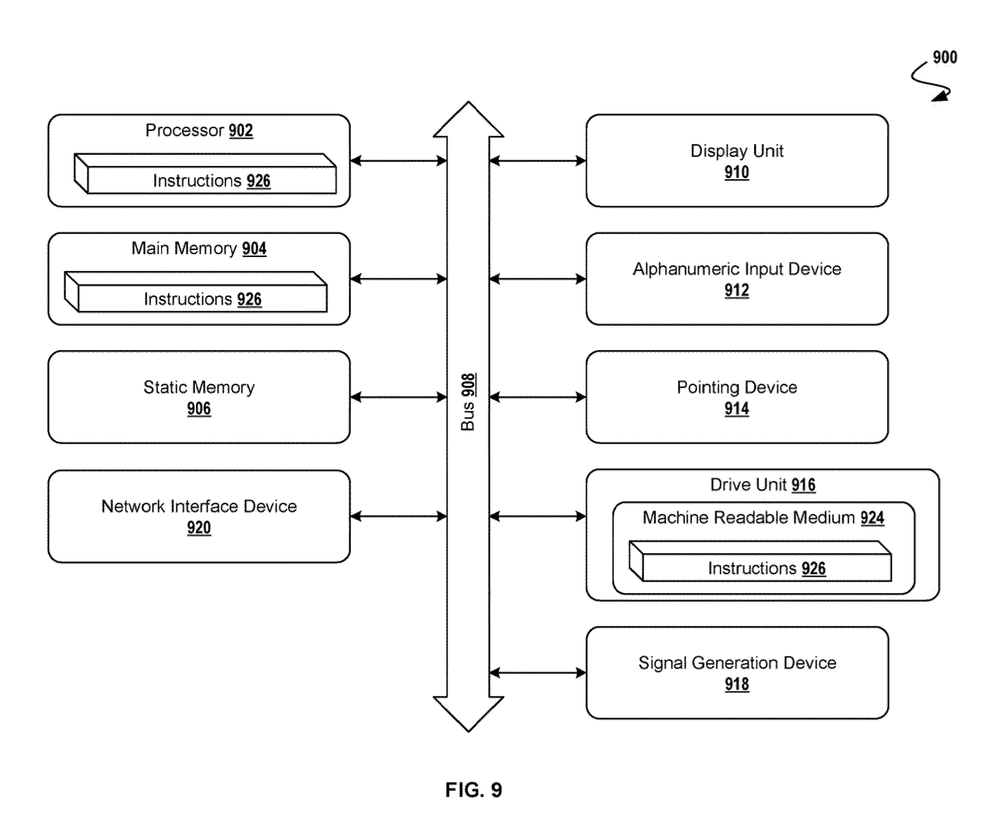

FIG. 9 depicts a diagrammatic representation of a machine in the exemplary form of a computer system 900 within which a set of instructions, for causing the machine to perform any one of the methodologies discussed above, may be executed. In alternative embodiments, the machine may comprise a network router, a network switch, a network bridge, Personal Digital Assistant (PDA), a cellular telephone, a web appliance or any machine capable of executing a sequence of instructions that specify actions to be taken by that machine.

The computer system 900 includes a processor 902, a main memory 904 and a static memory 906, which communicate with each other via a bus 908. The computer system 900 may further include a video display unit 910 (e.g., an LED display, or a liquid crystal display (LCD) or a cathode ray tube (CRT)), which can be used singly or in combination to form a single display surface or multiple display surfaces. The computer system 900 also includes an alphanumeric input device 912 (e.g., a keyboard), a pointing device 914 (e.g., a mouse), a disk drive unit 916, a signal generation device 918 (e.g., a speaker), and a network interface device 920.

The disk drive unit 916 includes a machine-readable medium 924 on which is stored a set of instructions 926 (e.g., software) embodying any one, or all, of the methodologies described above. The instructions 926 are also shown to reside, completely or at least partially, within the main memory 904 and/or within the processor 902. The instructions 926 may further be transmitted or received via the network interface device 920.

The computer system 900 can be used to implement a client system and/or a server system and/or any portion of network infrastructure.

It is to be understood that various embodiments may be used as or to support software programs executed upon some form of processing core (such as the CPU of a computer) or otherwise implemented or realized upon or within a machine or computer readable medium. A machine-readable medium includes any mechanism for storing or transmitting information in a form readable by a machine (e.g., a computer). For example, a machine-readable medium includes read-only memory (ROM); random access memory (RAM); magnetic disk storage media; optical storage media; flash memory devices; or any other type of non-transitory media suitable for storing or transmitting information.

A module as used herein can be implemented using any mix of any portions of the system memory, and any extent of hard-wired circuitry including hard-wired circuitry embodied as a processor 902.

In the foregoing specification, the disclosure has been described with reference to specific embodiments thereof. It will, however, be evident that various modifications and changes may be made thereto without departing from the broader spirit and scope of the disclosure. For example, the above-described process flows are described with reference to a particular ordering of process actions. However, the ordering of many of the described process actions may be changed without affecting the scope or operation of the disclosure. The specification and drawings are, accordingly, to be regarded in an illustrative sense rather than in a restrictive sense.

What is claimed is:

1. A computer implemented method comprising:
using a computing system having at least one processor to perform a process, the process comprising:
displaying a maximum efficiency response curve of a media portfolio, the maximum efficiency response curve comprising a range of response values resulting from a set of media portfolio input characteristics;
displaying a maximum efficiency ROI curve of the media portfolio, the maximum efficiency ROI curve comprising a range of ROI values resulting from the set of media portfolio input characteristics;
accepting a change to alter the media portfolio input characteristics in the media portfolio; and
displaying one or more reallocation values based at least in part on the change.

2. The method of claim 1, wherein the one or more reallocation values comprise at least one of, a reallocation response value, and a reallocation ROI value.

3. The method of claim 2, further comprising displaying, on a single display surface the maximum efficiency response curve and the reallocation response value.

4. The method of claim 2, further comprising displaying, on a single display surface the maximum efficiency ROI curve and the reallocation ROI value.

5. The method of claim 1, further comprising displaying a reallocation ROI value.

6. The method of claim 1, wherein the change comprises at least one of, an allocation change, a spending change, and a user price change.

7. The method of claim 1, wherein the maximum efficiency response curve is calculated using an efficient frontier algorithm.

8. The method of claim 1, wherein the maximum efficiency response curve is calculated using an exhaustive apportioner algorithm.

9. A computer program product embodied in a non-transitory computer readable medium, the computer readable medium having stored thereon a sequence of instructions which, when executed by a processor causes the processor to execute a process, the process comprising:
displaying a maximum efficiency response curve of a media portfolio, the maximum efficiency response curve comprising a range of response values resulting from a set of media portfolio input characteristics;
displaying a maximum efficiency ROI curve of the media portfolio, the maximum efficiency ROI curve comprising a range of ROI values resulting from the set of media portfolio input characteristics;
accepting a change to alter the media portfolio input characteristics in the media portfolio; and
displaying one or more reallocation values based at least in part on the change.

10. The computer program product of claim 9, wherein the one or more reallocation values comprise at least one of, a reallocation response value, and a reallocation ROI value.

11. The computer program product of claim 10, further comprising instructions for displaying, on a single display surface the maximum efficiency response curve and the reallocation response value.

12. The computer program product of claim 10, further comprising instructions for displaying, on a single display surface the maximum efficiency ROI curve and the reallocation ROI value.

13. The computer program product of claim 9, further comprising displaying a reallocation ROI value.

14. The computer program product of claim 9, wherein the change comprises at least one of, an allocation change, a spending change, and a user price change.

15. The computer program product of claim 9, wherein the maximum efficiency response curve is calculated using an efficient frontier algorithm.

16. A computer system comprising:
a computer processor to execute a set of program code instructions; and
a memory to hold the program code instructions, in which the program code instructions comprises program code to perform,
displaying a maximum efficiency response curve of a media portfolio, the maximum efficiency response curve comprising a range of response values resulting from a set of media portfolio input characteristics;
displaying a maximum efficiency ROI curve of the media portfolio, the maximum efficiency ROI curve comprising a range of ROI values resulting from the set of media portfolio input characteristics;
accepting a change to alter the media portfolio input characteristics in the media portfolio; and
displaying one or more reallocation values based at least in part on the change.

17. The computer system of claim 16, wherein the one or more reallocation values comprise at least one of, a reallocation response value, and a reallocation ROI value.

18. The computer system of claim 17, further comprising displaying, on a single display surface the maximum efficiency response curve and the reallocation response value.

19. The computer system of claim 17, further comprising displaying, on a single display surface the maximum efficiency ROI curve and the reallocation ROI value.

20. The computer system of claim 16, wherein the change comprises at least one of, an allocation change, a spending change, and a user price change.
